(19) United States
(12) Patent Application Publication
(10) Pub. No.: US 2008/0217885 A1
(43) Pub. Date: Sep. 11, 2008

(54) TRAILER HITCH ALIGNMENT ASSEMBLY KIT

(76) Inventors: Stephen Neal Woolever, Auburn, GA (US); Michael Htchins, Monroe, GA (US)

Correspondence Address: GEORGE R. REARDON, 3356 STATION COURT, LAWRENCVILLE, GA, 30044, US

(21) Appl. No.: 11/683,426

(22) Filed: Mar. 7, 2007

(51) Int. Cl. B60D 1/36

(52) U.S. Cl. 280/477

(57) ABSTRACT

A kit for a trailer hitch alignment assembly is disclosed. The assembly elements may include a base assembly and a wing assembly having pivotal elements for guiding the trailer hitch connection process. The assembly elements may also include a trailer tongue element, protective covers, a container and instructions on assembly and use.

### FIELD OF THE INVENTION

The present invention relates to a trailer hitch assembly and, more particularly, to a trailer hitch assembly kit that includes pivotal elements for directing a trailer tongue into alignment for a ball on a hitch.

### BACKGROUND OF THE INVENTION

As is well understood in the art, some vehicles are equipped with a towing hitch that allows a trailer or other towed vehicle to be coupled thereto so that the towing vehicle can tow the trailer. Generally, the trailer hitch is mounted to a rear support structure of the towing vehicle proximate the vehicle's bumper, and includes a hitch ball having a certain diameter. The towed vehicle typically includes a trailer tongue that extends from a front end of the towed vehicle. The trailer tongue includes a cup in which the hitch ball is positioned to couple the hitch to the trailer tongue. A securing mechanism within the cup, such as a metal flap, is selectively positioned around the ball when it is inserted in the cup to securely hold the tongue to the hitch.

When the towed vehicle is detached from the towing vehicle, the trailer tongue is generally supported on an adjustable front leg or stand so that the cup is positioned higher than the ball of the hitch. When the operator of the towing vehicle attaches the tongue to the hitch, he will back up the towing vehicle to position the hitch ball just below the cup. Once in this position, the tongue is lowered onto the ball by cranking down the stand using a jack device.

Generally it takes a significant amount of experience and skill for the vehicle operator to accurately position the hitch ball below the tongue cup when backing up the towing vehicle to connect the towed vehicle to the towing vehicle. Regardless of the operator's skill and experience, it is nearly impossible to exactly position the hitch ball at the proper location. Therefore, the operator usually must use the trailer tongue to manually move the towed vehicle in a right or left or front or back direction to provide the exact alignment. Because the towed vehicle may be large, heavy and cumbersome to move, this is sometimes a very difficult task.

It would be desirable to provide a hitch that assisted the towing vehicle operator to align the tongue cup to the hitch ball when attaching a towed vehicle to a towing vehicle.

It is well known in the art that some of the existing devices addressing this problem are complicated and cost prohibitive. Other devices quickly get worn and weathered after frequent use.

Related art that addresses these and other problems includes the following patents.

U.S. Pat. No. 3,420,549, issued to Robinson on Jan. 7, 1969, discloses a trailer hitch mounted at the rear of a vehicle including a pivot member and a pair of movable guard and guide members that are mounted for movement and locking at a first position wherein a portion of each member extends at an angle to the rear of the vehicle and provides a guiding surface for guiding the tongue of a trailer tongue toward the pivot member and a second position wherein the guiding surfaces extend in a direction generally parallel to the rear of the vehicle.

U.S. Pat. No. 4,226,438, issued to Collins on Oct. 7, 1980, discloses a guide surrounding a trailer hitch ball that protects the bumper and the rear end of the vehicle from damage by the trailer hitch member during connection thereof, and comprises a plate secured under the trailer hitch ball and having vertically extending wall portions which join at the rear of the trailer hitch ball in an obtuse dihedral angle. The guide functions to guide the trailer hitch member into cooperating engagement with the trailer hitch ball carried on the vehicle without allowing the same to engage the bumper or rear end portion of the vehicle. The side walls of the guide are sufficiently high to protect the trailer hitch ball from engaging and locking with the bumper of a vehicle used to push the vehicle having the trailer hitch ball installed.

U.S. Pat. No. 4,254,968, issued to DelVecchio on Mar. 10, 1981, discloses a removable ball guiding attachment to the tongue of a trailer hitch having two diverging members guiding the ball of the trailer hitch in correct position with respect to the clamp on the tongue of the hitch.

U.S. Pat. No. 4,416,466, issued to Park on Nov. 22, 1983, discloses a trailer hitch guide for guiding a ball, attached at the rear of an automobile or other towing vehicle, into a position of alignment directly under a socket on a trailer tongue of a trailer or other towed vehicle, the tongue being attached to the top surface of the trailer hitch guide. A v-flange on the bottom surface of the guide guides the ball into the position of alignment. Once the ball is in this position, the trailer hitch guide is removed in order to drop the socket of the trailer tongue over the towing ball.

U.S. Pat. No. 4,560,183, issued to Cook on Dec. 24, 1985, discloses a trailer hitch guide that mounts a base upon the vehicle hitch and a pair of detachably, mountable, lateral guides are attachable to the base for projecting rearwardly therefrom. A first cam surface is provided which is connectable to said base and a second cam surface is connectable to the trailer tongue. The first and second cam surfaces are formed to cooperate to cause relative vertical displacement between the vehicle hitch and the trailer tongue as the vehicle hitch approaches the trailer tongue. The trailer tongue is aligned in a horizontal plane and raised in a vertical plane during the approach until the socket on the trailer tongue is positioned over the ball hitch. The trailer tongue is then dropped upon the ball hitch engaging the socket over the ball. The lateral guides and cam surfaces are removable as necessary to facilitate freedom of angular movement between the trailer hitch and the trailer tongue.

U.S. Pat. No. 4,781,394, issued to Schwarz et al. on Nov. 1, 1988, discloses a trailer hitch for attachment to a vehicle bumper for providing releasable coupling with a trailer coupling member. The hitch includes a coupling ball partially surrounded by an enclosure extending above the top of the coupling ball. A safety bar is received in slots formed in the surrounding wall. The safety bar, when installed, overlies the coupled arrangement of a ball joint and trailer coupling member so as to prevent their unintended separation. Further, the walls surrounding the coupling ball are pivotally mounted to the vehicle bumper and include a spring which contacts either the vehicle or its bumper to orient the enclosing walls in a preferred direction.

U.S. Pat. No. 4,840,392, issued to Baskett on Jun. 20, 1989, discloses a trailer hitch guide that provides a temporary, removable V-shaped fence partly embracing a hitch ball for guiding a trailer tongue into place to fit over the ball. The guide is provided as an attachment made up in part of a flat plate having a central opening for accommodating the hitch ball, and this opening is elongated fore and aft to enable selective positioning of the plate relative to the ball so as to assure a proper location of the other part, which is a hitch fence mountable on the plate. Attachment of the fence to the plate is effected by downwardly and rearwardly directed studs on the fence that removably fit openings in the plate, the shape of the studs counteracting the forward thrust of the trailer tongue during hitching and also enabling easy mounting and dismounting of the fence to and from the plate, which remains on the towing vehicle hitch structure as by welding or attaching bolts.

U.S. Pat. No. 4,844,496, issued to Webb et al. on Jul. 4, 1989, discloses a slidably positionable trailer hitch guide apparatus wherein a trailer hitch guide is formed with a plurality of vertically oriented flanges formed with a connecting plate overlying a slot formed in each vertical flange wherein the slots are aligned with one another and the plate is formed with a “U” shaped recess for accepting a securement ball for use in cooperation with a connecting trailer socket. The vertical flanges each have secured thereto a directing flange formed at an obtuse angle relative to said vertical flange with an underlying connecting flange at an obtuse angle to said plate. A plurality of stabilizing webs are orthogonally and outwardly projectingly secured to each vertical flange for stabilizing the guide apparatus relative to an automotive type bumper having secured thereto the securement ball.

U.S. Pat. No. 4,871,184, issued to Johnson on Oct. 3, 1989, discloses a guide assembly of the type removably mounted in cooperative relation to a hitch ball secured to a vehicle or like structure in a conventional manner wherein the guide assembly, once in an operative position relative to the hitch ball, will serve to direct the distal free end of a coupling tongue into engagement with the hitch ball so as to facilitate coupling therebetween with a minimum effort exerted by the operator of the vehicle on which the hitch ball is mounted.

U.S. Pat. No. 4,871,185, issued to Chakroff et al. on Oct. 3, 1989, discloses a trailer tongue alignment guide for centering the socket of a ball-type hitch above the ball as a vehicle is backed toward the trailer. A base plate having a flat bottom surface has a hole which is aligned with the hole in the vehicle draw bar so that the base plate is clamped between the ball and the draw bar by means of the ball fastener. No portion of this base plate extends into any substantial engagement with other portions of the vehicle or with the draw bar and therefore the base plate may be easily mounted to any conventional, existing ball-type draw bar. A rigid, V-guide is removably mounted to the base plate by means of engaging male and female coupling members formed on the base plate and the guide. These permit the guide to be simply lifted and removed from the base plate after the trailer socket is engaged with the ball, thus preventing the V-guide from restricting the articulation of the trailer with respect to the towing vehicle during turns

U.S. Pat. No. 5,330,196, issued to Ricles on Jul. 19, 1994, discloses a trailer hitch for use with a towing vehicle having a hitch ball on a rearwardly extending bar support, a V-shaped guide to facilitate hitching a trailer to the ball in which to position the guide to withstand hitching forces it is mounted vertical in the clearance between adjacent walls and has a notch in a lower edge which also forms a tongue and groove connection with the bar support.

U.S. Pat. No. 5,465,992, issued to Anderson on Nov. 14, 1995, discloses a base plate having an aperture which allows the plate to be mounted flatwise on a drawbar under the hitch ball. The base plate has a front integral wall of short height which allows side to side swinging movement of a trailer tongue over the top of it when the tongue is hitched to the ball. A flared trailer tongue guide is removably seated on the base plate in contact with the rear surface of the short front wall. The flared guide is locked in place by a pair of pivotal latch members having latch fingers that engage firmly against the bottom surface of the base plate. The aperture in the base plate is oblong to allow adjustment for the stop position of a trailer tongue as it bottoms out in the flared guide.

U.S. Pat. No. 5,529,330, issued to Roman on Jun. 25, 1996, discloses a two part assembly that allows one person from a vehicle to align a trailer onto any size hitch ball on a bumper or a receiver hitch in only one attempt. The first part of the two part assembly, the horizontal steel plate is attached to the bumper by its hitch ball. A similar horizontal steel plate is attached to a receiver hitch by its hitch ball also. The second part of the assembly, the V shaped guide, acts as the guide for the trailer tongue to be guided onto the hitch ball. The V shaped guide fits into the horizontal steel plate by its male dowels which are inserted into the female dowels of the horizontal steel plate. This extended V shaped guide will assist the towing vehicle in backing up to a trailer at any angle, allowing the trailer tongue to be guided onto the hitch ball of a bumper or receiver hitch that has a horizontal steel plate attached. The V shaped guide is then removed after the hitch ball has been locked into place. Both pieces of this two part assembly are easy to attach and remove, requiring no special tools or welding.

U.S. Pat. No. 5,549,316, issued to Jones on Aug. 27, 1996, discloses a guide, for guiding the towing tongue on a trailer onto the standard ball type hitch, which consists of vertical oriented plates attached to a horizontal plate which has an aperture that will receive the standard ball type hitch. The horizontal plate has an steel tube extension on it which will fit into the standard box receivers secured to a towing vehicle.

U.S. Pat. No. 5,779,256, issued to Vass on Jul. 14, 1998, discloses a hitch guide comprised of a generally V-shaped member mounted in a horizontal orientation with the base of the V forwardly of the ball and two arms extending rearwardly. The V-shaped guide member is releasably mounted on a horizontal plate underneath the ball by two vertical pins adjustably mounted on the arms which drop into holes in the plate. Thus the guide member is used only when backing up the towing vehicle to the hitch and guides the hitch coupling in the V-shape to a position directly over the ball. When aligned, the guide member is removed for regular towing.

U.S. Pat. No. 6,102,422, issued to Damron on Aug. 15, 2000, discloses a trailer hitch guide with a retractable yoke assembly. The yoke assembly presents, at its yoke end, a vee shaped receptacle to receive and guide a trailer hitch ball into contact with a trailer hitch. The yoke assembly yoke end is formed of at least one yoke guide, which positions the yoke assembly, received into at least one yoke guide receiver tube. The yoke end, in the preferred embodiment, is composed of a first and second yoke guide which are received respectively into the first and second yoke guide receiver tubes. A plate assembly is composed of a plate and a yoke guide receiver tube is affixed to either side of a trailer hitch tongue with each sized to receive a yoke guide. The yoke assembly is extended, when positioned to receive and guide a trailer hitch ball for connection with a trailer hitch, and fixed into the extended position by means including one or more pins. The yoke assembly is retracted, during trailer transit, with the yoke guides being retracted into the yoke guide receiver tubes and fixed with means including one or more pins.

U.S. Pat. No. 6,796,573 B2, issued to Beaudoin on Sep. 28, 2004, discloses a trailer hitch guide adapted to enable a vehicle operator to hitch a trailer to a vehicle without assistance and without leaving the confines of his cab. The guide assembly includes a mounting plate and a pivot plate adapted for attachment to a trailer tongue and two lateral guide plates pivotally attached to the pivot plate in a V-shaped configuration. A stop plate is disposed across the base of the V-shaped configuration. In use, the hitch guide pivots to an extended position beneath the hitch socket at the end of the trailer tongue to guide the ball under the socket, and pivots to a retracted position beneath the trailer tongue after alignment.

U.S. Pat. No. 6,874,804 B2, issued to Reese et al. on Apr. 5, 2005, discloses a hitch and receiver system that provides at least an additional vertical box receiver when a conventional box receiver of the vehicle hitch is in use to provide draw bar support for the hitch ball. In a second embodiment, an additional horizontal box receiver is also provided for the hitch and receiver system. The additional box receivers are used to hold and support various accessory devices. In some cases the hitch ball can be used to tow a trailer without removal of the accessory device. The unique accessory device of this invention includes one of a hitch guide accessory device, an access platform and step accessory device, and a cargo cage accessory device. The combination of a hitch and receiver “system” and an accessory device provides the “assembly” of this invention.

U.S. Pat. No. 6,976,694 B1, issued to Rayl et al. on Dec. 20, 2005, discloses a hitch assembly that includes a V-guide for directing a trailer tongue to a hitch ball on the hitch assembly so as to align a trailer tongue cup to the hitch ball. The hitch assembly includes guide wings pivotally mounted to a hitch post. When the guide wings are in the V-guide position, slideable rods on the guide wings are positioned behind the post to prevent the wings from pivoting. When the trailer is attached to the vehicle, the slideable rods are retracted so that the guide wings can pivot to a retracted position where the rods are slid into openings in the hitch post.

While these patents and other previous methods have attempted to solve the problems that they addressed, none have utilized or disclosed an easy to use, versatile trailer hitch assembly kit having removable protective, decorative covers, as does embodiments of the present invention.

Therefore, a need exists for a trailer hitch alignment assembly kit with these attributes and functionalities. The trailer hitch alignment assembly kit according to embodiments of the invention substantially departs from the conventional concepts and designs of the prior art. It can be appreciated that there exists a continuing need for a new and improved trailer hitch alignment assembly kit which can be used commercially. In this regard, the present invention substantially fulfills these objectives.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

In an exemplary embodiment, the trailer hitch alignment assembly kit disclosed herein comprises a base assembly and a wing assembly. The wing assembly cooperates with the base assembly to pivot from a non-guiding position to a V-shaped guiding position. In another embodiment, the trailer hitch alignment assembly kit may be further comprised of a tongue assembly.

The base assembly may be comprised of a base plate, a set of jam blocks affixed to the bottom of the base plate, a plurality of hinge bolt holes, a set of stop pin holes, a plurality of slide bolt holes, a hitch ball hole, and a set of stop pins dimensioned to fit snugly into the set of stop pin holes.

Depending on the embodiment of the present invention the set of spaced apart, substantially parallel, jam blocks may be further comprised of jam bolt holes into which jam bolts are inserted to securely hold a tongue assembly inserted into the space between the set of jam blocks.

The wing assembly may be comprised of a set of dock wings, a hinge bolt assembly affixed to the back of each dock wing and a slide bolt assembly affixed to the back of each dock wing. Each hinge bolt assembly may be further comprised of a hinge bolt sleeve, a hinge bolt and a hinge bolt fastener. Each slide bolt sleeve assembly may be further comprised of a slide bolt sleeve, a slide bolt, a slide bolt spring and a slide bolt spring lock.

In some embodiments the wing assembly may be further comprised of a set of dock wing covers that fit over the dock wings. Each dock wing cover may have one or more logo and/or other descriptive markings disposed thereon.

In some embodiments the trailer hitch alignment assembly kit may also include a tongue assembly. The tongue assembly may be welded or otherwise affixed to the bottom of the base plate, negating the need for jam blocks, jam block holes and jam block bolts.

One aspect of the present invention is that it helps protect the adjacent bumper during the alignment process.

Another aspect of the present invention is that each dock wing is independently adjustable from a substantially planar arrangement to a V-shaped arrangement.

Another aspect of the present invention is that it may be made in a variety of dimensions, thicknesses and durable materials, depending on the expected use and product life.

Another aspect of the present invention is that embodiments may exclude wing cover elements, jam block holes and jam block bolts and/or a tongue assembly element.

Another aspect of the present invention is that it may be made from readily available components.

Another aspect of the present invention is that it may be economically manufactured.

Another aspect of the present invention is that it may be made utilizing existing manufacturing techniques.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways for example in wet drawing applications. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description, taken in conjunction with the accompanying drawings in which:

FIG. 1 illustrates a front perspective view of a trailer hitch alignment assembly kit, according to an embodiment of the present invention.

FIG. 2 illustrates a rear perspective view of a trailer hitch alignment assembly kit, according to an embodiment of the present invention.

FIG. 3 illustrates a bottom perspective view of a trailer hitch alignment assembly kit, according to an embodiment of the present invention.

FIG. 4 illustrates a top plan view of a trailer hitch alignment assembly kit, according to an embodiment of the present invention.

FIG. 5 illustrates a front plan view of a trailer hitch alignment assembly kit, illustrating a set of dock wing covers, according to an embodiment of the present invention.

FIG. 6 illustrates a left side plan view of a trailer hitch alignment assembly kit, according to an embodiment of the present invention.

FIG. 7 illustrates a top plan view of a trailer hitch alignment assembly kit, illustrating movement of the dock wings to the guiding position, according to an embodiment of the present invention.

FIG. 8 illustrates a top front perspective view of a trailer hitch alignment assembly kit, illustrating the dock wings locked in the guiding position, according to an embodiment of the present invention.

FIG. 9 illustrates a top rear perspective view of a trailer hitch alignment assembly kit, according to an embodiment of the present invention.

FIG. 10A illustrates a rear exploded view of a trailer hitch alignment assembly kit, according to an embodiment of the present invention.

FIG. 10B illustrates a rear exploded view of a wing assembly for a trailer hitch alignment assembly kit, according to an embodiment of the present invention.

FIG. 10C illustrates a rear exploded view of a base assembly for a trailer hitch alignment assembly kit, according to an embodiment of the present invention.

FIG. 11A illustrates a front exploded view of a trailer hitch alignment assembly kit, according to an embodiment of the present invention where a tongue assembly is affixed, e.g. welded, to a base assembly.

FIG. 11B illustrates a front exploded view of a trailer hitch alignment assembly kit, according to an embodiment of the present invention that utilizes jam blocks to attach to a slider tongue.

FIG. 12 illustrates a bottom perspective view of a trailer hitch alignment assembly kit, according to an embodiment of the present invention where the tongue assembly is affixed, e.g., welded, to a base assembly.

FIG. 13 illustrates a bottom exploded view of a trailer hitch alignment assembly kit, according to an embodiment of the present invention

FIG. 14 illustrates a left side plan view of a trailer hitch alignment assembly kit, according to still another embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

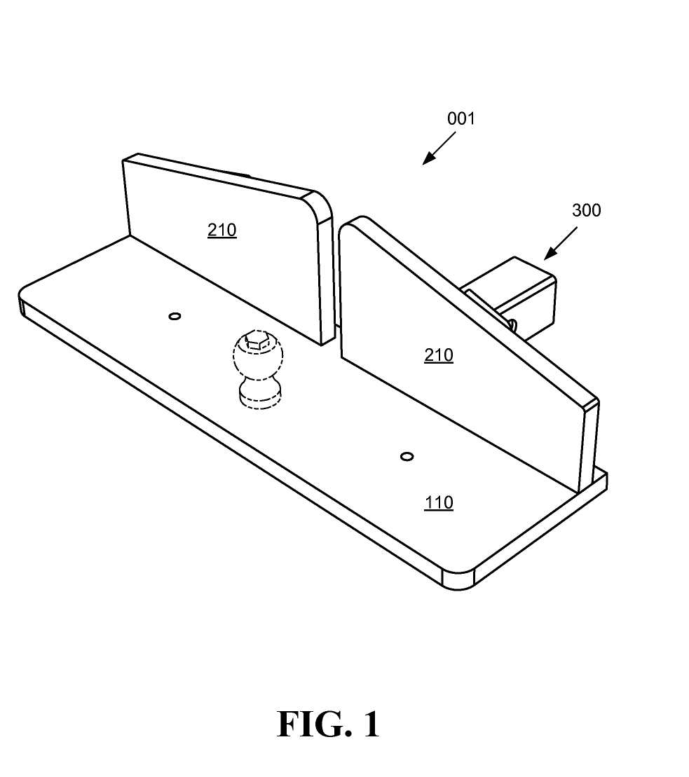

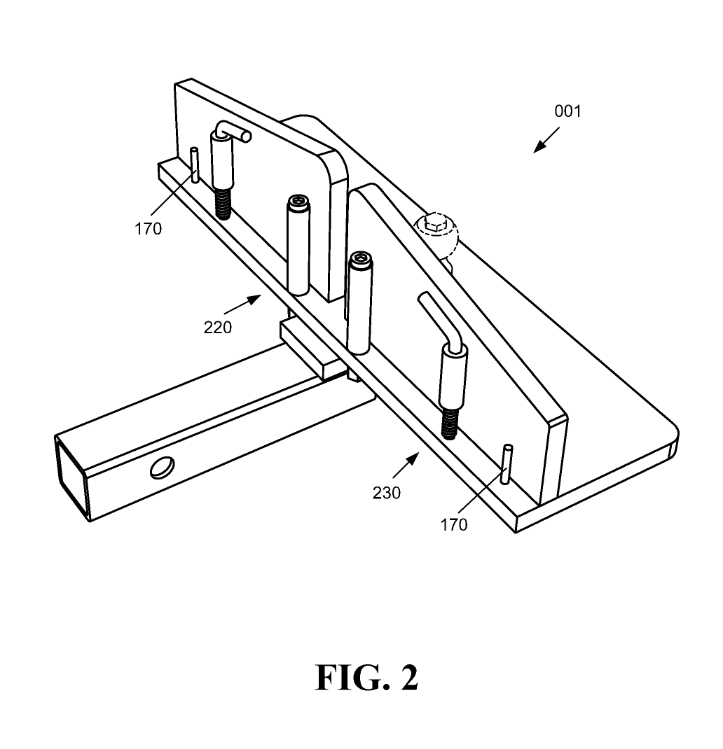

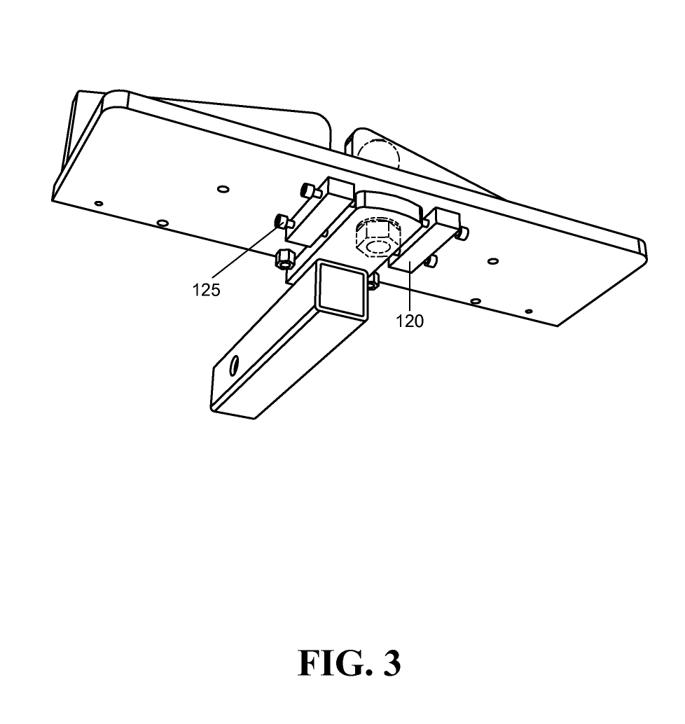

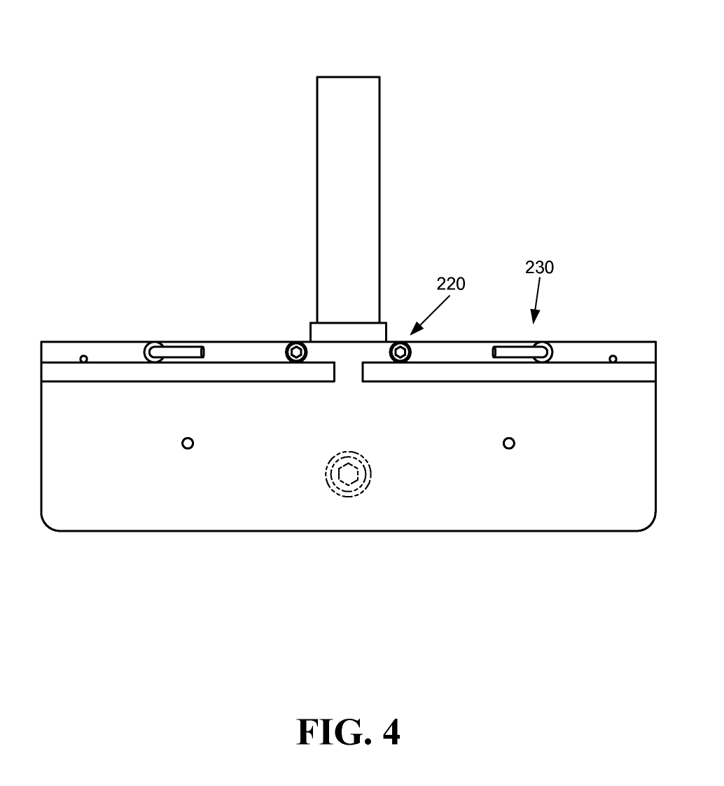

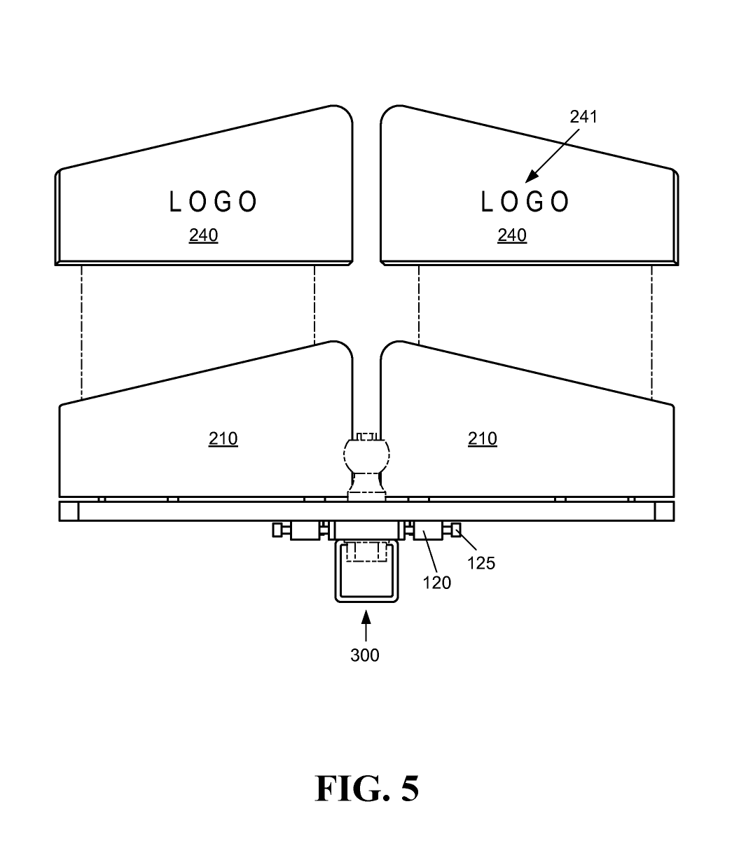

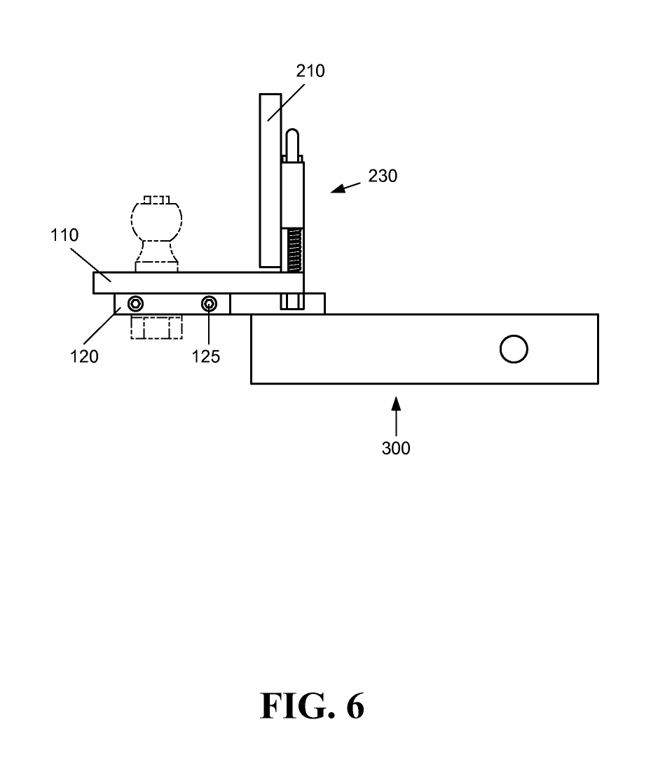

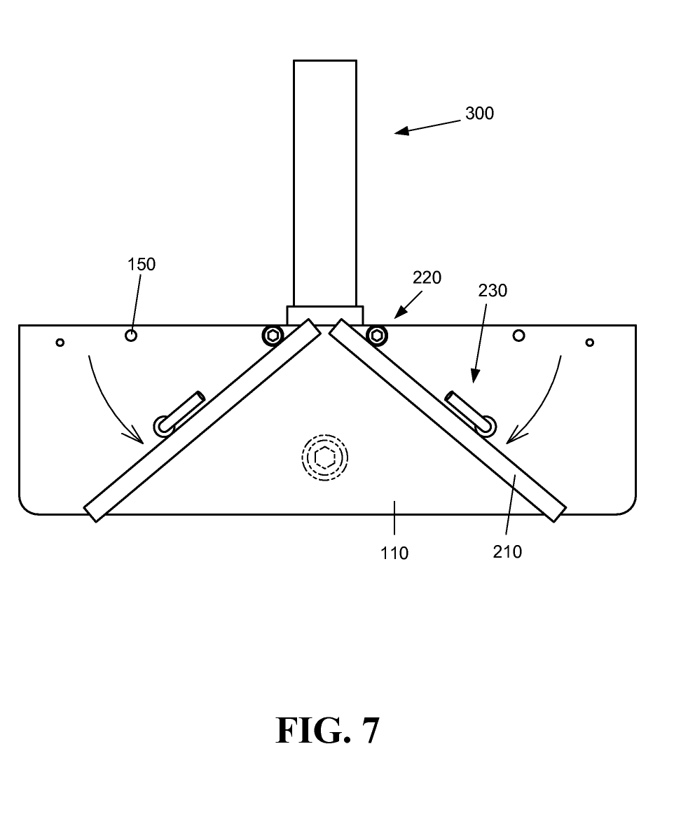

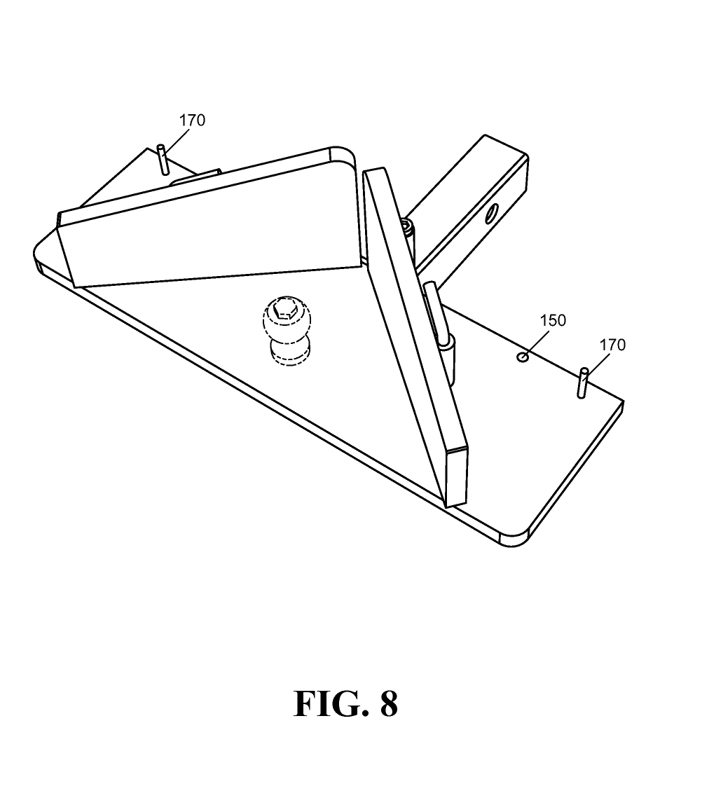

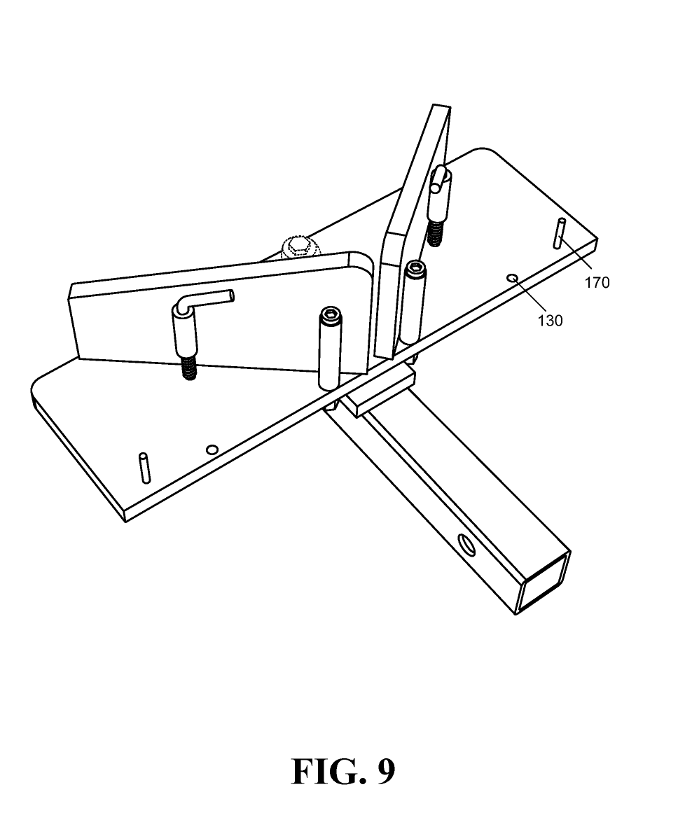

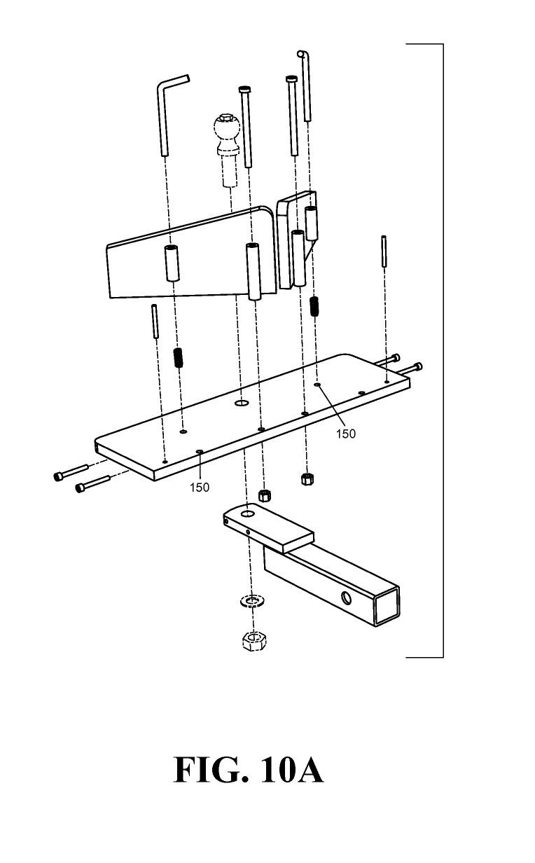

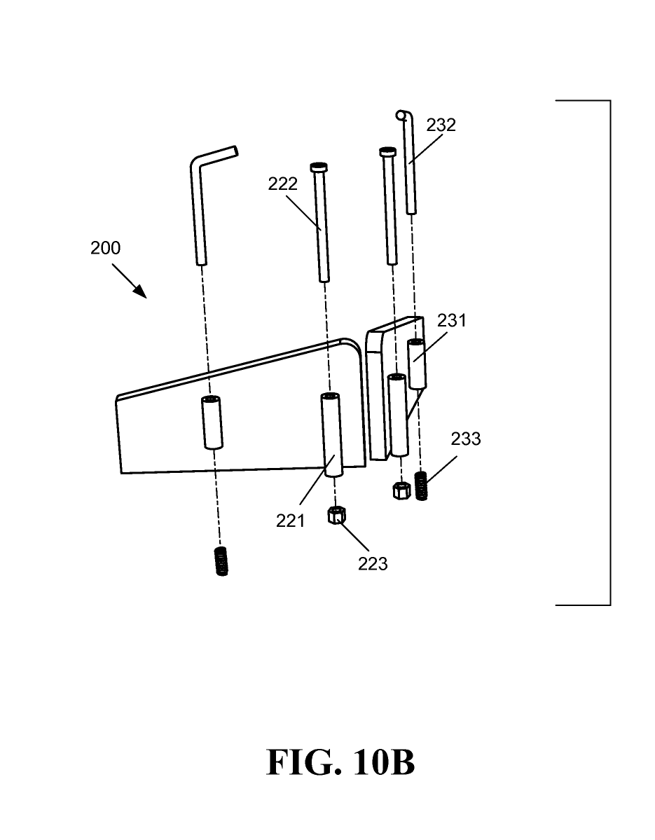

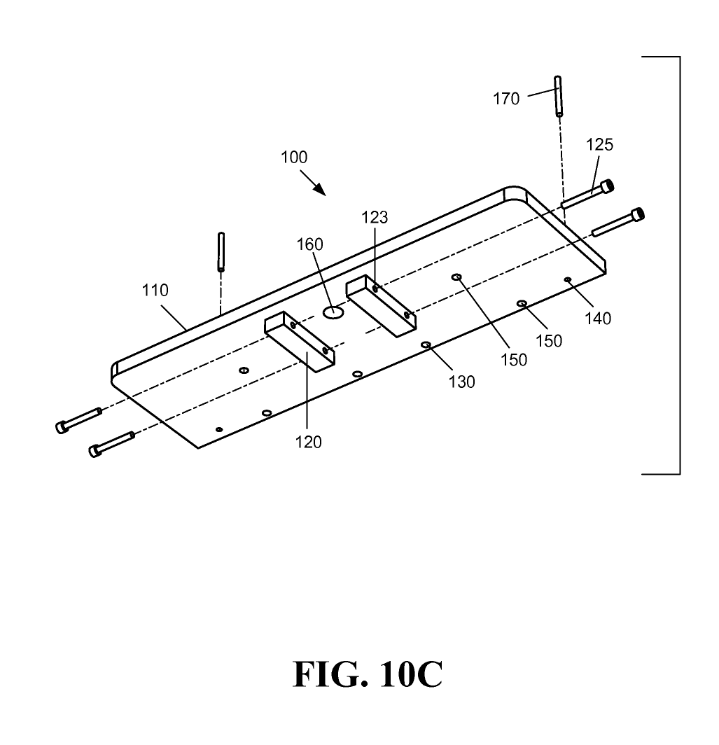

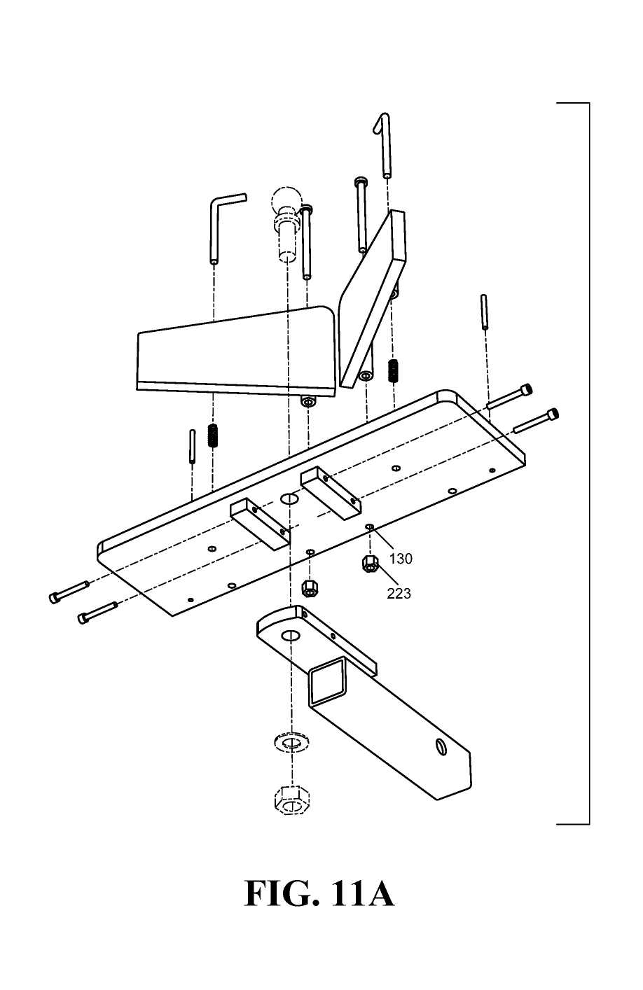

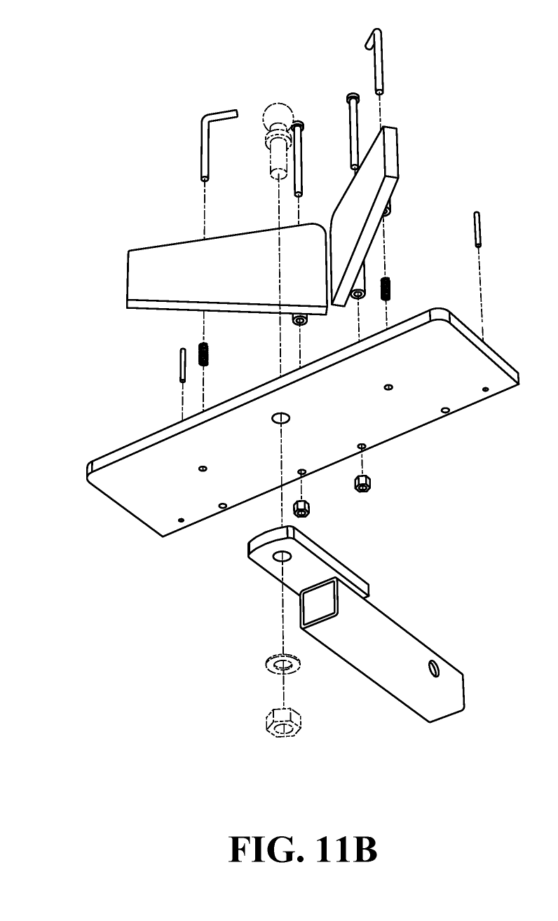

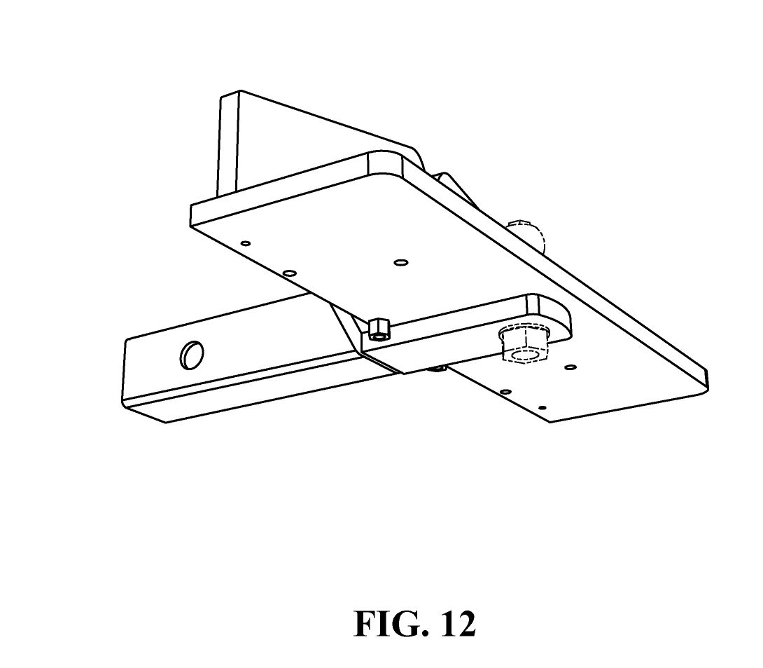

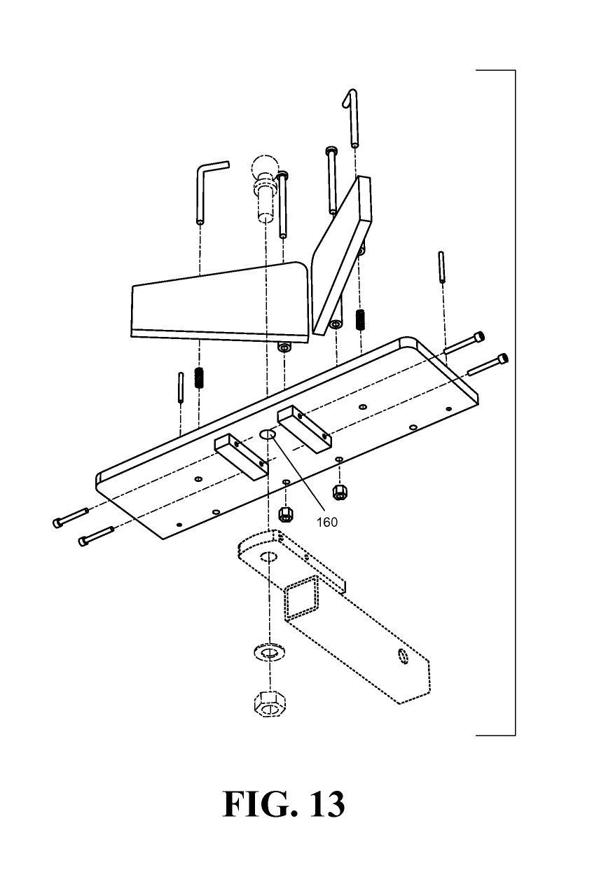

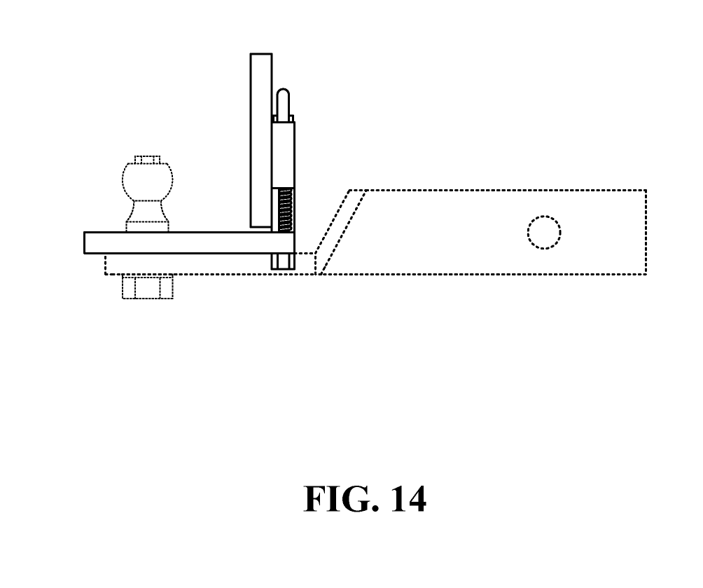

Referring now to FIG. 1 through FIG. 14, a trailer hitch alignment assembly kit 001 is comprised of a base assembly 100 and a wing assembly 200. In another embodiment, the trailer hitch alignment assembly kit may be further comprised of a tongue assembly 300.

The base assembly 100 may be comprised of a base plate 110, a set of jam blocks 120 affixed to the bottom of the base plate 110, a plurality of hinge bolt holes 130, a set of stop pin holes 140, a plurality of slide bolt holes 150, a hitch ball hole 160, and a set of stop pins 170 where each stop pin 170 is dimensioned to fit snugly into a stop pin hole 140.

Depending on the embodiment of the present invention the set of spaced apart, substantially parallel, each jam block 120 may be further comprised of one or more of a jam bolt hole 123 into which a jam bolt 125 is inserted to securely hold a tongue assembly that has been inserted into the space between the set of jam blocks.

The wing assembly 200 may be comprised of a set of dock wings 210, a hinge bolt assembly 220 affixed to the back of each dock wing 210 and a slide bolt assembly 230 affixed to the back of each dock wing 210.

Each hinge bolt assembly 220 may be further comprised of a hinge bolt sleeve 221, a hinge bolt 222 and a hinge bolt fastener 223.

Each slide bolt sleeve assembly 230 may be further comprised of a slide bolt sleeve 231, a slide bolt 232, a slide bolt spring 233 and a slide bolt spring lock (not shown). To move the wing assembly 200 from a non-guiding position to a guiding position a user pull each slide bolt 232 upwards to disengage each slide bolt 232 from the corresponding non-guiding slide bolt hole and pivots each dock wing 210 forward until its slide bolt is positioned directly over the corresponding guiding slide bolt hole. The user then releases each slide bolt so that it engages the corresponding guiding slide bolt hole.

In some embodiments the wing assembly may be further comprised of a set of dock wing covers 240 where each dock wing cover 240 is capable of being fit over a corresponding dock wing 210 and removed when desired, e.g. during the alignment docking process. Each dock wing cover 240 may have one or more logo 241 or other identifying markings disposed thereon. These markings may include branding, educational institution affiliations, charitable association affiliations, personal messages, sport affiliations, and the like. The trailer hitch alignment assembly kit 001 may include multiple dock wing covers with different themes.

In some embodiments the trailer hitch alignment assembly kit 001 may also include a tongue assembly 300. The tongue assembly 300 may be welded or otherwise affixed to the bottom of base plate 110, giving the option to eliminate jam blocks, jam block holes and jam block bolts if desired.

Embodiments of the trailer hitch alignment assembly kit 001 may include a container (not shown) formed and dimensioned to hold the kit elements.

Embodiments of the trailer hitch alignment assembly kit 001 may include instructions (not shown) pertaining to the use and care of the trailer hitch alignment assembly kit 001.

The trailer hitch alignment assembly kit elements may be formed for light duty, super duty or super heavy duty use, e.g. steel of varying thickness and strength.

From the foregoing, it will be appreciated that, although specific embodiments of the invention have been described herein for purposes of illustration, various modifications may be made without deviating from the spirit and scope of the invention. For example, many of the features and components described above in the context of a particular trailer hitch alignment assembly configuration can be incorporated into other configurations in accordance with other embodiments of the invention.

Accordingly, the invention is not limited except by the appended claims.

What is claimed is:

1. A trailer hitch alignment assembly kit comprised of:
a base assembly, and
a wing assembly, wherein the wing assembly is releasably attached to the base assembly,
wherein the base assembly is comprised of a base plate having a top and a bottom substantially coplanar with each other, at least two of a jam block affixed to the bottom of the base plate, wherein each jam block is formed to have two substantially parallel jam block holes, a plurality of a jam block bolt, a plurality of a jam block bolt fastener, a plurality of a hinge bolt hole disposed in the base plate, at least two of a stop pin hole disposed in the base plate, a plurality of a slide bolt hole disposed in the base plate, a hitch ball hole disposed in the base plate, and a set of a stop pin dimensioned to fit snugly into each stop pin hole, wherein the wing assembly is comprised of a set of a dock wing having a front and a back, a hinge bolt assembly affixed to the back of each dock wing and a slide bolt assembly affixed to the back of each dock wing, wherein each hinge bolt assembly is comprised of a hinge bolt sleeve, a hinge bolt and a hinge bolt fastener, wherein each slide bolt sleeve assembly is comprised of a slide bolt sleeve, a slide bolt, a slide bolt spring and a slide bolt spring lock.

2. The trailer hitch alignment assembly kit of claim 1, further comprising at least one set of a dock wing cover capable of being releasably fit over a corresponding dock wing.

3. The trailer hitch alignment assembly kit of claim 2, wherein at least one of the dock wing cover has an identifying marking disposed thereon.

4. The trailer hitch alignment assembly kit of claim 3, wherein the identifying marking pertains to a commercial logo.

5. The trailer hitch alignment assembly kit of claim 3, wherein the identifying marking pertains to a sports affiliation.

6. The trailer hitch alignment assembly kit of claim 3, wherein the identifying marking pertains to an educational institution affiliation.

7. The trailer hitch alignment assembly kit of claim 3, wherein the identifying marking pertains to a charitable association affiliation.

8. The trailer hitch alignment assembly kit of claim 3, wherein the identifying marking pertains to a personal message.

9. The trailer hitch alignment assembly kit of claim 3, further comprising an instruction sheet.

10. The trailer hitch alignment assembly kit of claim 9, further comprising a container dimensioned to hold the base assembly, the wing assembly, the at least one set of a dock wing cover and the instruction sheet.

11. A trailer hitch alignment assembly kit comprised of:
a base assembly,
a wing assembly, and
a tongue assembly,
wherein the wing assembly is releasably attached to the base assembly and the tongue assembly is affixed to the base assembly,
wherein the base assembly is comprised of a base plate having a top and a bottom substantially coplanar with each other, a plurality of a hinge bolt hole disposed in the base plate, at least two of a stop pin hole disposed in the base plate, a plurality of a slide bolt hole disposed in the base plate, a hitch ball hole disposed in the base plate, and a set of a stop pin dimensioned to fit snugly into each stop pin hole,
wherein the wing assembly is comprised of a set of a dock wing having a front and a back, a hinge bolt assembly affixed to the back of each dock wing and a slide bolt assembly affixed to the back of each dock wing, wherein each hinge bolt assembly is comprised of a hinge bolt sleeve, a hinge bolt and a hinge bolt fastener, wherein each slide bolt sleeve assembly is comprised of a slide bolt sleeve, a slide bolt, a slide bolt spring and a slide bolt spring lock.

12. The trailer hitch alignment assembly kit of claim 11, further comprising at least one set of a dock wing cover capable of being releasably fit over a corresponding dock wing.

13. The trailer hitch alignment assembly kit of claim 12, wherein at least one of the dock wing cover has an identifying marking disposed thereon.

14. The trailer hitch alignment assembly kit of claim 13, wherein the identifying marking pertains to a commercial logo.

15. The trailer hitch alignment assembly kit of claim 13, wherein the identifying marking pertains to a sports affiliation.

16. The trailer hitch alignment assembly kit of claim 13, wherein the identifying marking pertains to an educational institution affiliation.

17. The trailer hitch alignment assembly kit of claim 13, wherein the identifying marking pertains to a charitable association affiliation.

18. The trailer hitch alignment assembly kit of claim 13, wherein the identifying marking pertains to a personal message.

19. The trailer hitch alignment assembly kit of claim 13, further comprising an instruction sheet.

20. The trailer hitch alignment assembly kit of claim 19, further comprising a container dimensioned to hold the base assembly, the wing assembly, the tongue assembly, the at least one set of a dock wing cover and the instruction sheet.
